(19) United States
(12) Patent Application Publication
(10) Pub. No.: US 2018/0212881 A1
(43) Pub. Date: Jul. 26, 2018

(54) LOAD-BASED COMPRESSION OF FORWARDING TABLES IN NETWORK DEVICES

(71) Applicant: LinkedIn Corporation, Sunnyvale, CA (US)

(72) Inventors: Russell I. White, Apex, NC (US); Shafagh Zandi, San Francisco, CA (US); Zaid A. Kahn, San Francisco, CA (US)

(73) Assignee: LinkedIn Corporation, Sunnyvale, CA (US)

(21) Appl. No.: 15/411,457

(22) Filed: Jan. 20, 2017

(51) Int. Cl. H04L 12/803; H04L 12/26; H04L 12/741

(52) U.S. Cl. CPC H04L 47/125; H04L 45/54; H04L 43/0882

(57) ABSTRACT

The disclosed embodiments provide a system that performs load-based compression of a forwarding table for a node in a network. During operation, the system obtains link utilizations for a set of physical links connected to the node. Next, the system uses the link utilizations to update a set of entries in a forwarding table of the node for use in balancing load across the set of physical links. The system then uses the set of entries to process network traffic at the node.

### BACKGROUND

### Field

The disclosed embodiments relate to routing in networks. More specifically, the disclosed embodiments relate to techniques for performing load-based compression of forwarding tables in network devices.

### Related Art

Switch fabrics are commonly used to route traffic within data centers. For example, network traffic may be transmitted to, from, or between servers in a data center using an access layer of “leaf” switches connected to a fabric of “spine” switches. Traffic from a first server to a second server may be received at a first leaf switch to which the first server is connected, routed or switched through the fabric to a second leaf switch, and forwarded from the second leaf switch to the second server.

To balance load across a switch fabric, an equal-cost multi-path (ECMP) routing strategy may be used to distribute flows across different paths in the switch fabric. However, such routing may complicate visibility into the flows across the switch fabric, prevent selection of specific paths for specific flows, and result in suboptimal network link utilization when bandwidth utilization across flows is unevenly distributed. Moreover, conventional techniques for compressing a large number of routing table entries in the switches into a smaller number of forwarding table entries typically aim to install the least amount of forwarding information required to reach all destinations in the network instead of selecting entries that improve balancing or routing of network traffic across network links.

### BRIEF DESCRIPTION OF THE FIGURES

FIG. 1 shows a switch fabric in accordance with the disclosed embodiments.

FIG. 2 shows the load-based compression of forwarding table entries for a node in a network in accordance with the disclosed embodiments.

FIG. 3 shows an exemplary reachable address space in a network in accordance with the disclosed embodiments.

FIG. 4 shows a flowchart illustrating a process of compressing a forwarding table of a node in a network in accordance with the disclosed embodiments.

FIG. 5 shows a flowchart illustrating a process of updating a set of routing entries in a forwarding table for use in balancing load across a set of physical links connected to a node in a network in accordance with the disclosed embodiments.

FIG. 6 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

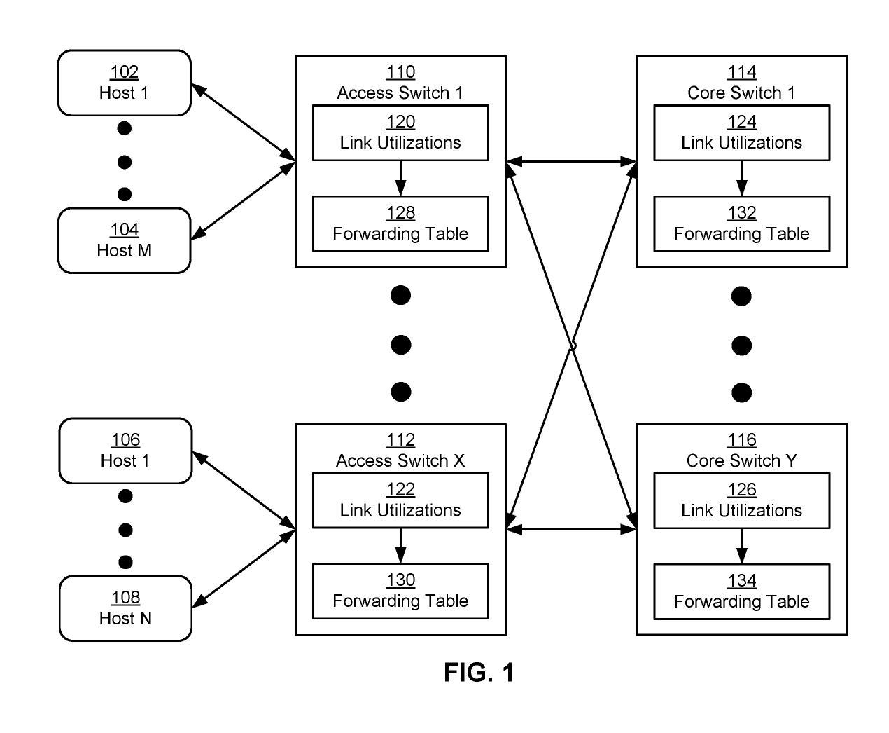

The disclosed embodiments provide a method, apparatus, and system for improving the use of forwarding tables in network devices. More specifically, the disclosed embodiments provide a method, apparatus, and system for performing load-based compression of forwarding tables in network devices. As shown in FIG. 1, a network may include a switch fabric containing a number of access switches (e.g., access switch 1 110, access switch x 112) connected to a set of core switches (e.g., core switch 1 114, core switch y 116) via a set of physical and/or logical links.

Switches in the switch fabric may be connected in a hierarchical and/or layered topology, such as a leaf-spine topology, fat tree topology, Clos topology, and/or star topology. For example, each access switch may include a “top of rack” (ToR) switch, “end of row” switch, leaf switch, and/or another type of switch that provides connection points to the switch fabric for a set of hosts (e.g., servers, storage arrays, etc.). Each core switch may be an intermediate switch, spine switch, super-spine switch, and/or another type of switch that routes traffic among the connection points.

The switch fabric may be used to route traffic to, from, or between nodes connected to the switch fabric, such as a set of hosts (e.g., host 1 102, host m 104) connected to access switch 1 110 and a different set of hosts (e.g., host 1 106, host n 108) connected to access switch x 112. For example, the switch fabric may include an InfiniB and (InfiniBand™ is a registered trademark of InfiniB and Trade Association Corp.), Ethernet, Peripheral Component Interconnect Express (PCIe), and/or other interconnection mechanism among compute and/or storage nodes in a data center. Within the data center, the switch fabric may route north-south network flows between external client devices and servers connected to the access switches and/or east-west network flows between the servers.

During routing of traffic through the switch fabric, the switches may use an equal-cost multi-path (ECMP) strategy and/or other multipath routing strategy to distribute flows across different paths in the switch fabric. For example, the switches may distribute load across the switch fabric by selecting paths for network flows using a hash of flow-related data in packet headers. However, conventional techniques for performing load balancing in switch fabrics may result in less visibility into flows across the network links, an inability to select specific paths for specific flows, and uneven network link utilization when bandwidth utilization is unevenly distributed across flows.

At the same time, routing table entries in the switches are typically compressed into a smaller number of entries in forwarding tables 128-134 of the switches without considering the distribution of load across links in the switch fabric. For example, a routing table stored in random access memory (RAM) of a switch may store more than 200,000 entries, while a forwarding table stored in content-addressable memory (CAM) in the same switch may have space for only 100,000 entries. To compress available routes from the routing table to fit in the forwarding table, the switch may install a minimal set of routes that will cover the reachable address space in the network. Alternatively, the switch may install the longest set of prefixes across all adjacencies and the entire set of reachable destinations within the size constraints of the forwarding table. An ECMP strategy may then be used to select one of the installed routes for a flow, which may utilize a subset of all available routes along which the flow may be directed.

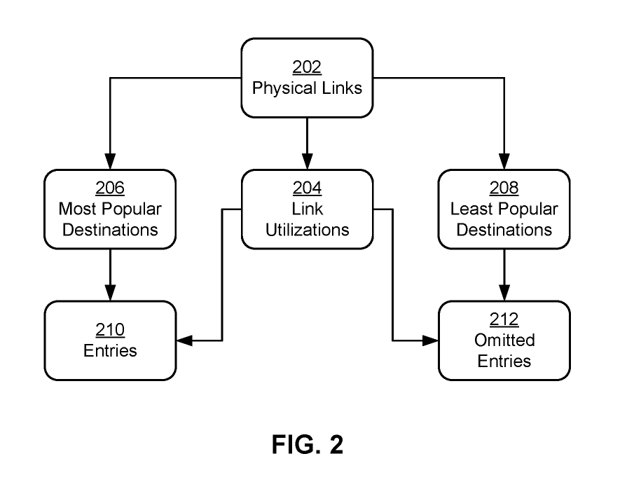

In one or more embodiments, routing or balancing of network traffic in the switch fabric is improved by performing load-based compression of forwarding table entries in the switches. As described in further detail below with respect to FIG. 2, each switch and/or other network device in the switch fabric may update its forwarding table (e.g., forwarding tables 128-134) based on link utilizations (e.g., link utilizations 120-126) of links connected to the network device. For example, the network device may include the link utilizations in entries of the forwarding table for subsequent use in balancing load across the links and/or omit a subset of entries from the forwarding table to reduce utilization of links associated with the entries. Consequently, the network device may update or remove entries in the forwarding table in a way that balances traffic dynamically across the links without exceeding the size constraints of the forwarding table.

FIG. 2 shows the load-based compression of forwarding table entries for a node in a network in accordance with the disclosed embodiments. As mentioned above, the node may be connected to other nodes in the network via a set of physical links 202. The node may obtain a set of link utilizations 204 of the physical links, as well as a set of most popular destinations 206 and a set of least popular destinations 208 that are reachable via the physical links. For example, the node may obtain link utilizations for its physical links using an internal monitoring mechanism and/or a network monitoring protocol such as syslog, Simple Network Management Protocol (SNMP), and/or sampled flow (sFlow). The node may also obtain the most and least popular destinations associated with each of the physical links from a centralized controller and/or using a network protocol. The most and least popular destinations may be based on the frequency of flows to the destinations, the size of the flows (e.g., elephant versus mice flows), and/or other attributes of network traffic to the destinations. Thus, a more popular destination may be specified more frequently in network traffic and/or receive a significant proportion of network traffic, and a less popular destination may be identified less frequently in network traffic and/or receive a small amount of network traffic.

The node may use link utilizations 204, most popular destinations 206, and/or least popular destinations 208 to generate and/or modify its forwarding table in a way that balances load across physical links 202. First, the node may include link utilizations 204 in entries 210 of the forwarding table that are associated with the most popular destinations that are reachable via the physical links. For example, the node may add percentage utilizations of the physical links to forwarding table entries used to reach the most popular destinations, in descending order of destination popularity, until the size limit of the forwarding table is reached.

In turn, a forwarding engine at the node may use link utilizations 204 in entries 210 to balance load across physical links 202. For example, the forwarding engine may use ECMP to calculate a hash, highest random weight, and/or other value from packet header fields that define a flow and/or forwarding table entries associated with the flow to distribute network traffic across multiple paths of equal cost from the node to a given destination. When link utilizations 204 for the paths are included in the forwarding table, the forwarding engine may include the link utilizations in the calculation of the value so that links that have been more heavily utilized are selected less frequently than links that have been less heavily utilized.

The node may alternatively, or additionally, use link utilizations 204 and least popular destinations 208 to update the forwarding table with a set of omitted entries 212. For example, the node may selectively remove entries associated with high utilization of the corresponding physical links 202 from the forwarding table to reduce subsequent use of the physical links. To mitigate unintentional congestion of links resulting from a reduction in available routes associated with the removed entries, the node may omit, for the highly utilized links, forwarding table entries associated with the least popular destinations reachable via the links. By periodically and/or dynamically adding link utilizations 204 that consume space in the forwarding table and removing entries that free up space in the forwarding table, the node may meet the space constraints of the forwarding table while using the forwarding table to balance traffic across multiple physical links 202 to the same destinations.

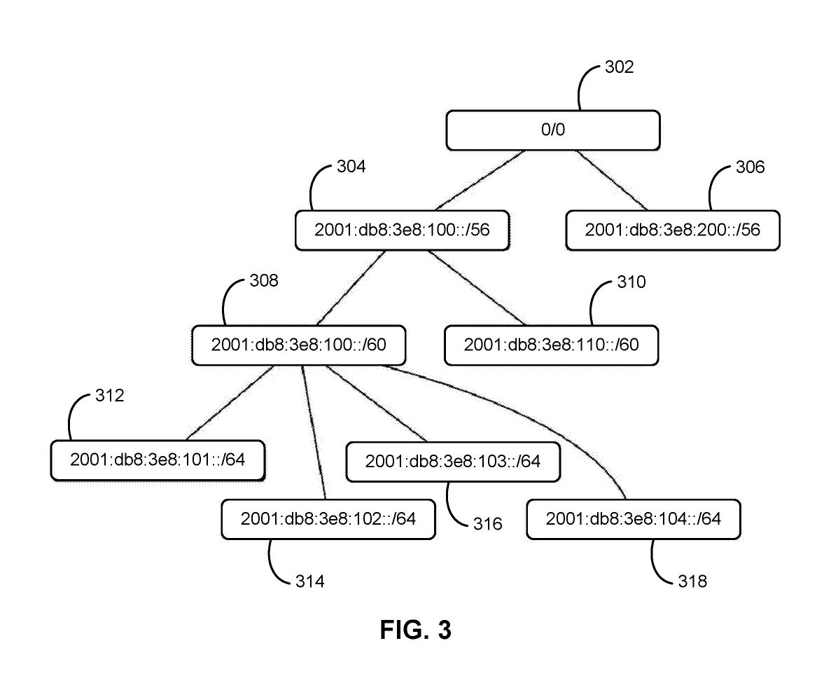

The compression technique of FIG. 2 may be used to forward network traffic to destinations within the exemplary reachable address space of FIG. 3. As shown in FIG. 3, the address space is modeled using a tree with a root node 302 that has an Internet Protocol version 6 (IPv6) address of 0 and a subnet mask of 0. Node 302 has two child nodes 304-306 with respective IPv6 addresses of 2001:db8:3e8:100 and 2001:db8:3e8:200 and the same subnet mask of 56. Node 304 has two child nodes 308-310 with respective IPv6 addresses of 2001:db8:3e8:100 and 2001:db8:3e8:110 and the same subnet mask of 60. Node 308 has four child nodes 312-318 with respective IPv6 addresses of 2001:db8:3e8:101, 2001:db8:3e8:102, 2001:db8:3e8:103, and 2001:db8:3e8:104 and the same subnet mask of 64.

A conventional technique for compressing forwarding table entries for subnetworks in the address space may identify nodes 304-306 as links through which all destinations are reachable and install entries for both nodes in the forwarding table. A different conventional technique for compressing the forwarding table entries may install, in a forwarding table that fits seven entries, entries for nodes 302-310. The same technique may omit entries for nodes 312-318 from the forwarding table to remain within the size limit of the forwarding table and because nodes 312-318 can be reached via the entry for node 308.

To improve balancing of load across links used to reach the subnetworks in the address space, the forwarding table may be modified to include link utilizations of the links. For example, a switch with two links may have a forwarding table with the following routes and link utilizations:

| Routes | 1^{st} Link Utilization | 2^{nd} Link Utilization |
|---|---|---|
| 0/0 | 35% | 65% |
| 2001:db8:3e8:100::/60 | 40% | 60% |
| 2001:db8:3e8:110::/60 | 40% | 60% |
| 2001:db8:3e8:101::/64 | 50% | 50% |
| 2001:db8:3e8:102::/64 | 50% | 50% |
| 2001:db8:3e8:103::/64 | 50% | 50% |
| 2001:db8:3e8:104::/64 | 50% | 50% |

Because the second link is more heavily loaded than the first link by network traffic associated with the first three routes in the forwarding table, the link utilizations may be included with the first three routes in the forwarding table. In turn, a forwarding mechanism in the switch may include the link utilizations in calculating a hash and/or other value for selecting between the links in forwarding network traffic along the first three routes.

The forwarding table may also, or instead, be modified by removing links with high utilization from forwarding table entries associated with less popular destinations. For example, a subset of links with the highest link utilizations may be removed from an ECMP set in the forwarding table to prevent use of the links in forwarding network traffic associated with the corresponding flow, thereby reducing the overall utilization of the links.

Such load-based forwarding table compression may also, or instead, account for flow size to the destinations. For example, the node may identify a given destination as a target of an elephant flow and reduce the forwarding information on one member of an ECMP set for the destination to the elephant flow, thereby causing the member to transmit network traffic for just the elephant flow. The node may then rebalance other flows to the destination based on link utilization, destination popularity, and/or other attributes, as discussed above.

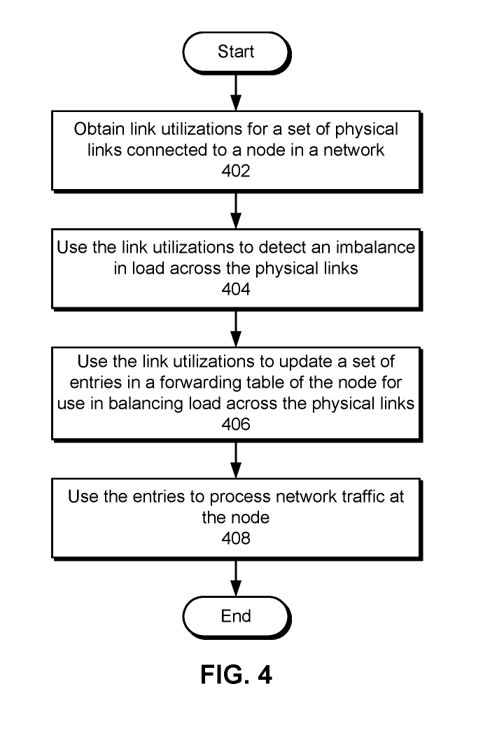

FIG. 4 shows a flowchart illustrating a process of compressing a forwarding table of a node in a network in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

Initially, link utilizations for a set of physical links connected to the node are obtained (operation 402). The node may be a switch, router, and/or other network device that is connected to a number of other network devices in the network via interfaces representing the physical links. The link utilizations may be obtained from a monitoring mechanism in the node and/or one or more protocols for monitoring the operation of network devices.

Next, the link utilizations are used to detect an imbalance in load across the physical links (operation 404). For example, the link utilizations may include percentage and/or proportional utilizations of the links for various routes in the network. A load imbalance may be detected when the utilization of a given link exceeds a threshold. In addition, the threshold may be adjusted based on the number of links across which network traffic received at the node can be balanced. For example, the threshold for an imbalance in load across two links may be set to 60% utilization of one link, which is 1.5 times higher than a 40% utilization of the other link. If the load can be spread across five links, the threshold may be adjusted to 33.33% utilization of one link, which is 1.5 times higher than an average 22.22% utilization of the remaining four links.

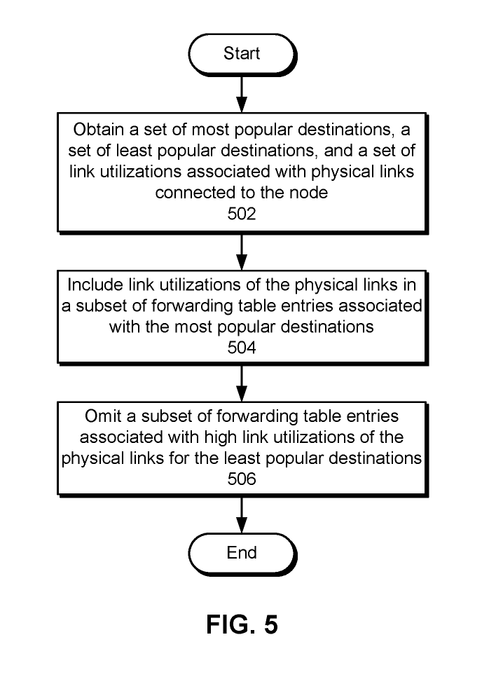

The link utilizations are then used to update a set of entries in a forwarding table of the node for use in balancing the load across the physical links (operation 406), as described in further detail below with respect to FIG. 5. Finally, the entries are used to process network traffic at the node (operation 408). For example, the updated entries may be used with ECMP routing of the network traffic so that links in a given ECMP set of the forwarding table are equally used. Operations 402-408 may also be repeated on a periodic basis and/or when the link utilizations change beyond or exceed a threshold.

FIG. 5 shows a flowchart illustrating a process of updating a set of routing entries in a forwarding table for use in balancing load across a set of physical links connected to a node in a network in accordance with the disclosed embodiments. In one or more embodiments, one or more of the steps may be omitted, repeated, and/or performed in a different order. Accordingly, the specific arrangement of steps shown in FIG. 5 should not be construed as limiting the scope of the embodiments.

First, a set of most popular destinations, a set of least popular destinations, and a set of link utilizations associated with physical links connected to the node are obtained (operation 502). The destination popularities and/or link utilizations may be obtained by the node and/or from a centralized network controller. Next, link utilizations of the physical links are included in a subset of forwarding table entries associated with the most popular destinations (operation 504). For example, the link utilizations may be added to the forwarding table in descending order of destination popularity until the size limit of the forwarding table is reached. In turn, a hash and/or other value may be generated from one or more of the link utilizations and used to select a link for forwarding network traffic from the node.

A subset of forwarding table entries associated with high link utilizations of the physical links is omitted for the least popular destinations (operation 506). For example, forwarding table entries for links with high link utilizations may be removed in ascending order of destination popularity to reduce the overall load on the links. The omitted entries may free up space in the forwarding table, allowing additional link utilizations and/or other entries to be added to the forwarding table to further balance network traffic across the physical links.

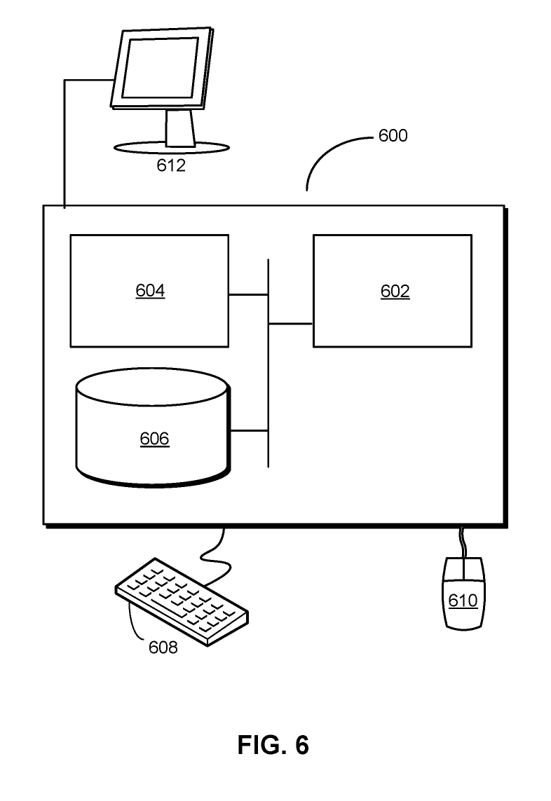

FIG. 6 shows a computer system 600 in accordance with an embodiment. Computer system 600 includes a processor 602, memory 604, storage 606, and/or other components found in electronic computing devices. Processor 602 may support parallel processing and/or multi-threaded operation with other processors in computer system 600. Computer system 600 may also include input/output (I/O) devices such as a keyboard 608, a mouse 610, and a display 612.

Computer system 600 may include functionality to execute various components of the present embodiments. In particular, computer system 600 may include an operating system (not shown) that coordinates the use of hardware and software resources on computer system 600, as well as one or more applications that perform specialized tasks for the user. To perform tasks for the user, applications may obtain the use of hardware resources on computer system 600 from the operating system, as well as interact with the user through a hardware and/or software framework provided by the operating system.

In one or more embodiments, computer system 600 provides a system for performing load-based compression of a forwarding table for a node in a network. The system may obtain link utilizations for a set of physical links connected to the node. Next, the system may use the link utilizations to update a set of entries in a forwarding table of the node for use in balancing load across the set of physical links. The system may then use the set of entries to process network traffic at the node.

In addition, one or more components of computer system 600 may be remotely located and connected to the other components over a network. Portions of the present embodiments may also be located on different nodes of a distributed system that implements the embodiments. For example, the present embodiments may be implemented using a cloud computing system that dynamically inserts and removes information from forwarding tables of each node in a remote network to balance network traffic across physical links connected to the node.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining, at a node in a network, link utilizations for a set of physical links connected to the node;
using the link utilizations to update, by the node, a set of entries in a forwarding table of the node for use in balancing load across the set of physical links; and
using the set of entries to process network traffic at the node.

2. The method of claim 1, wherein using the link utilizations to update the set of entries in the forwarding table for use in balancing the load across the set of physical links comprises:
including the link utilizations in a subset of the entries in the forwarding table for use in selecting routes for network traffic received at the node.

3. The method of claim 2, wherein using the set of entries to process network traffic at the node comprises:
generating a hash from one or more of the link utilizations; and
using the hash to select a link in the physical links for use in forwarding the network traffic from the node.

4. The method of claim 2, wherein the subset of the entries is associated with a set of most popular destinations reachable via the physical links.

5. The method of claim 1, wherein using the link utilizations to update the set of entries in the forwarding table for use in balancing the load across the set of physical links comprises:
omitting a subset of the entries from the forwarding table based on the link utilizations.

6. The method of claim 5, wherein the subset of the entries is associated with a set of least popular destinations reachable via the physical links.

7. The method of claim 6, wherein the subset of the entries is further associated with high link utilizations for the physical links.

8. The method of claim 1, further comprising:
using the link utilizations to detect an imbalance in the load across the physical links prior to generating the entries in the forwarding table.

9. The method of claim 1, wherein using the link utilizations to update the set of entries in the forwarding table for use in balancing the load across the set of physical links comprises:
including the link utilizations in a first subset of the entries in the forwarding table; and
omitting a second subset of the entries from the forwarding table based on the link utilizations.

10. The method of claim 1, wherein the link utilizations comprise a percentage utilization of a physical link in the set of physical links.

11. An apparatus, comprising:
one or more processors; and
memory storing instructions that, when executed by the one or more processors, cause the apparatus to:
obtain link utilizations for a set of physical links connected to a node in a network;
using the link utilizations to update a set of entries in a forwarding table of the node for use in balancing load across the set of physical links; and
use the set of entries to process network traffic at the node.

12. The apparatus of claim 11, wherein using the link utilizations to update the set of entries in the forwarding table for use in balancing the load across the set of physical links comprises:
including the link utilizations in a subset of the entries in the forwarding table for use in selecting routes for network traffic received at the node.

13. The apparatus of claim 12, wherein using the set of entries to process network traffic at the node comprises:
generating a hash from one or more of the link utilizations; and
using the hash to select a link in the physical links for use in forwarding the network traffic from the node.

14. The apparatus of claim 12, wherein the subset of the entries is associated with a set of most popular destinations reachable via the physical links.

15. The apparatus of claim 11, wherein using the link utilizations to update the set of entries in the forwarding table for use in balancing load across the set of physical links comprises:
omitting a subset of the entries from the forwarding table based on the link utilizations.

16. The apparatus of claim 15, wherein the subset of the entries is associated with high link utilizations of the physical links for a set of least popular destinations reachable via the physical links.

17. The apparatus of claim 11, wherein using the link utilizations to update the set of entries in the forwarding table for use in balancing the load across the set of physical links comprises:
including the link utilizations in a first subset of the entries in the forwarding table; and
omitting a second subset of the entries from the forwarding table based on the link utilizations.

18. A system, comprising:
a network comprising a set of nodes connected by a set of links; and
a node in the set of nodes, wherein the node comprises a non-transitory computer-readable medium comprising instructions that, when executed, cause the system to:
obtain link utilizations for a set of physical links connected to a node in a network;
using the link utilizations to update a set of entries in a forwarding table of the node for use in balancing load across the set of physical links; and
use the set of entries to process network traffic at the node.

19. The system of claim 18, wherein using the link utilizations to update the set of entries in the forwarding table for use in balancing the load across the set of physical links comprises:
including the link utilizations in a subset of the entries in the forwarding table for use in selecting routes for network traffic received at the node.

20. The system of claim 18, wherein using the link utilizations to update the set of entries in the forwarding table for use in balancing the load across the set of physical links comprises:
omitting a subset of the entries from the forwarding table based on the link utilizations.
